(19) United States
(12) Patent Application Publication
(10) Pub. No.: US 2005/0163465 A1
(43) Pub. Date: Jul. 28, 2005

(54) Method and interface for controlling a digital recording apparatus

(75) Inventors: Valerie Sacrez Liebhold, Carmel, IN (US); Anthony Edward Stuart, Zionsville, IN (US); Scott Allan Kendall, Westfield, IN (US)

Correspondence Address: THOMSON LICENSING INC., PATENT OPERATIONS, PO BOX 5312, PRINCETON, NJ, 08543-5312, US

(73) Assignee: Thomson Licensing S.A., F-92100 Boulogne-Billancourt (FR)

(21) Appl. No.: 10/512,357

(22) PCT Filed: Apr. 14, 2003
(86) PCT No.: PCT/US03/11449

Related U.S. Application Data
(60) Provisional application No. 60/374,884, filed on Apr. 23, 2002.

(51) Int. Cl. H04N 5/76; H04N 5/781

(52) U.S. Cl. 386/46; 386/125

(57) ABSTRACT

A digital recording apparatus and a method for controlling a digital recording apparatus that provides for allowing the user to easily determine the available recording time that remains on a memory of the apparatus in response to a record command. According to an exemplary embodiment, the method includes steps of detecting a first user input representing a command to start recording, and enabling display of a first screen message responsive to the first user input, where the first screen message indicates a remaining recording time available on a memory of the apparatus. The command to start recording is a command that does not specify a total recording time, for example, by the user actuating a RECORD key on a remote control device associated with the apparatus. The present invention also automatically provides another screen message that allows the user to delete data from the memory if it is determined that insufficient available recording time remains on the memory.

This application claims priority to and all benefits accruing from a provisional application filed in the United States Patent and Trademark Office on Apr. 23, 2002, and there assigned Ser. No. 60/374,884.

### BACKGROUND OF THE INVENTION

1. Field of the Invention

The present invention generally relates to a digital recording apparatus and a method for controlling a digital recording apparatus, and more particularly, to a digital recording apparatus and a method for controlling a digital recording apparatus for allowing a user to easily determine the amount of recording time available on a memory of the apparatus in response to user activation of a record function.

2. Background Information

Personal video recorders (PVRs) are digital recording apparatuses that provide various features such as allowing a user to select for recording, by means of a graphical user interface (GUI) displayed on an associated television set, monitor, or other display device, a television program to be broadcast at a future time or which is currently being broadcast. Such apparatuses digitally record the selected program onto a storage module, such as a hard disk, and upon user command playback the stored program by retrieving it from storage, decompressing or decoding the program and outputting the video signal to an associated television set, monitor, or other display device. Apparatuses having such capabilities are currently sold under trade names such as “TiVo,” “RePlayTV,” “Sky+,” and “Showstopper.”

Such devices offer features and advantages in controlling the recording and playback of programs that were previously not available to the consumer via analog recording devices. The features include the ability to pause a live program on the screen while continuing to record the program onto a storage device such that the user can continue playback of the program at their convenience without missing any portion of the currently broadcast program, and also simultaneously recording and playing back, either the same program or different programs, thereby providing great flexibility in recording and playing back the received video signals. Since the programs are digitally stored and processed, the devices also allow the user to have greater control of the playback, for example, instantly skipping ahead by the predetermined amount of time. Such devices also generally are designed to work with a program guide that allows the user to easily see, in a grid format, program schedules, and to select a particular program for recording. The devices may also include input terminals for connecting playback devices, such as a camcorder, to the PVR to digitally record the contents of the devices onto the PVR for later playback.

However, with current digital recording apparatuses, when a user presses the “RECORD” key to initiate a recording operation, or inputs another command to start a recording operation without specifying a total recording time, he or she does not readily know whether the recording apparatus has enough available memory space to actually complete the desired recording operation. For example, if the user desires to record a television program that is currently being broadcast and has a duration of 2 hours, and the recording apparatus has only 1 hour and 30 minutes of available memory space remaining, then the final 30 minutes of the television program will not be recorded. This can be extremely inconvenient and frustrating for the user who expects to record the entire television program after pressing the “RECORD” key on the remote control. Additionally, known systems do not provide for easily deleting the data currently on the memory upon determination that there is insufficient available recording time, and providing immediate feedback to the user as to the revised available recording time so that the user can easily determine whether the revised available recording time is sufficient.

Accordingly, there is a need for a method for controlling a digital recording apparatus that avoids the foregoing problems, and thereby allows the user to easily determine the available recording time remaining on the memory of the recording apparatus, and delete data stored on the memory as desired and allow the user to easily evaluate the revised available recording time on the memory. The present invention addresses these and other issues.

### SUMMARY OF THE INVENTION

In accordance with an aspect of the present invention, a digital recording apparatus and a method for controlling a digital recording apparatus is disclosed. According to an exemplary embodiment, the method comprises steps of detecting a first user input representing a command to start recording, and enabling display of a first screen message responsive to the first user input. The first screen message indicates a remaining recording time available on a memory of the apparatus.

In accordance with another aspect of the present invention, a digital recording apparatus is disclosed. According to an exemplary embodiment, the apparatus comprises memory means for storing digital data. Processing means is provided for detecting a first user input representing a command to start recording. Image generating means is provided for enabling display of a first screen message responsive to the processing means detecting the first user input, the first screen message indicating a remaining recording time available on the memory means.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a digital recording apparatus suitable for implementing the present invention;

FIG. 2 is a flowchart illustrating exemplary steps for implementing a method according to the present invention;

FIG. 3 is an exemplary screen message according to the present invention;

FIG. 4 is another exemplary screen message according to the present invention;

FIG. 5 is a flowchart illustrating exemplary steps for implementing another embodiment of the present invention; and

FIG. 6 is another exemplary screen message according to the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

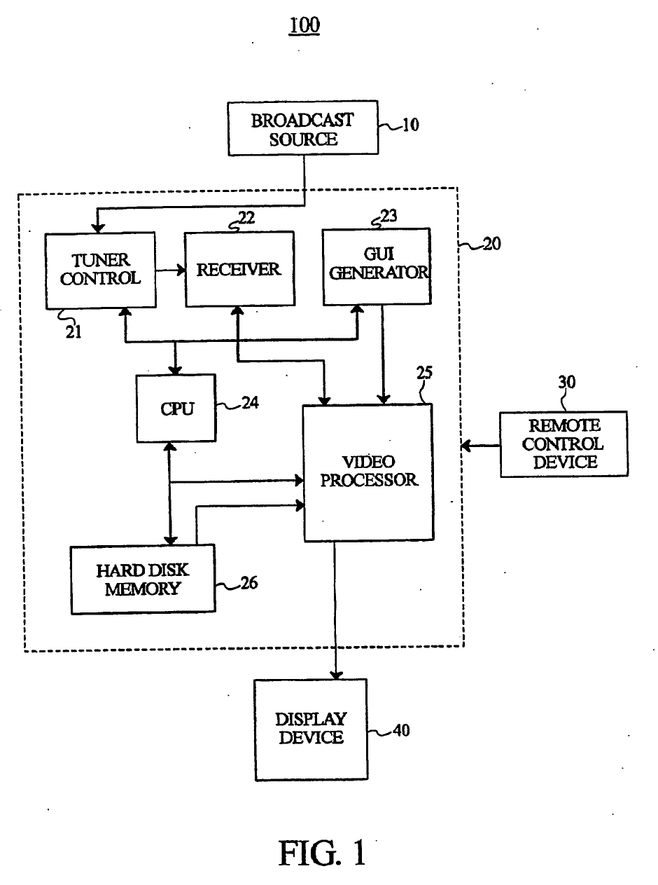

Referring now to the drawings, and more particularly to FIG. 1, an environment 100 suitable for implementing the present invention is shown. As shown in FIG. 1, environment 100 comprises a digital recording device 20, which includes various elements for receiving and processing program signals and generating audio and video signals suitable for display. Digital recording device 20 is coupled to a broadcast source 10 for receiving program signals, a remote control device 30 for receiving user input signals, and a display device 40 for providing a program display. Display device 40 may be included with the elements of digital recording device 20 as an integrated package. Also shown in FIG. 1, digital recording apparatus 20 comprises a tuner control block 21, a receiver 22, a GUI generator 23, a central processing unit (CPU) 24, a video processor 25, and a hard disk memory 26. As will be intuitive to those skilled in the art, many of the foregoing elements, or combination of elements, of apparatus 20 may be embodied using integrated circuits (ICs). In FIG. 1, broadcast source 10 is operative to provide data including video signals to digital recording apparatus 20 for recording. Broadcast source 10 may for example provide data to apparatus 10 via a terrestrial, satellite, cable, internet, or other type of wired or wireless communication link. Broadcast source 10 may also represent a live or recorded broadcast source provided through a device connected to digital recording apparatus 20 such as one provided from a camcorder, DVD player or other similar device.

Digital recording apparatus 20 is operative to digitally record data provided from broadcast source 10, and may be embodied as a PVR or other digital video recording device, such as a digital versatile disk (DVD) recording device. According to an exemplary embodiment, tuner control block 21 is operative to receive data from broadcast source 10 and perform a tuning function to generate tuned signals. Receiver 22 is operative to receive and process the tuned signals provided from tuner control block 21 to thereby generate corresponding IF and baseband signals. GUI generator 23 is operative to generate GUI displays (e.g., bitmap images) corresponding to different operating modes of apparatus 20. GUI displays are generated and displayed on display device 40 to, for example, provide status information regarding the operation of apparatus 20, or menus for allowing the user to make various selections to control the operation of apparatus 20. As will be discussed later herein, a user may provide inputs to apparatus 20 responsive to such GUI displays to control the operation of apparatus 20.

CPU 24 is operative to perform the overall control of the various components of apparatus 20. According to an exemplary embodiment, CPU 24 generates various control signals, which control the operation of the other elements of apparatus 20 to provide the known digital recording features, such as pausing a portion of the received video on the display device 40 while continuing to record the incoming video on hard drive memory 26 for future playback. Video processor 25 is operative to perform various video processing functions of apparatus 20, such as decompressing, decoding, encoding, etc, to generate video signals suitable for display on device 40. According to an exemplary embodiment, video processor 25 processes and formats video signals provided from receiver 22, as well as video data retrieved from hard disk memory 26 to enable corresponding visual displays on display device 40, for example in the NTSC or PAL format. Video processor 25 may also combine such video images with GUI displays generated by GUI generator 23. The combination may be implemented with a switching device (not shown) that switches between the video signal and the GUI signal to overlay the GUI display onto the program display. Hard disk memory 26 is operative to store digital video data under the control of CPU 24. A table or listing of programs stored on the hard disk may be stored on the hard disk under the control of CPU 24. The programs and the listing of programs may be stored on the hard disk using conventionally known methods, including using contiguous or non-contiguous blocks of data that are identified using a file allocation table. The listing may also be stored on a memory device separate from the hard disk. Although memory 26 is shown in FIG. 1 as a hard disk memory for purposes of example, it may also be embodied in another form that is capable of storing large amounts of digital video data, such as one or more optical disks, flash memory, removable hard disk, solid state memory or the like.

Remote control device 30 is operative to provide user control inputs to digital recording apparatus 20, and may for example be embodied as a hand-held remote control, keyboard, or other input device such as an input terminal integral with apparatus 20. Remote control device 30 may be coupled to a receiver (not shown) contained in recording apparatus 20 via a wired or wireless medium, for example RF or IR signaling. According to an exemplary embodiment, a user may use remote control device 30 to transmit commands to control the various operating modes of apparatus 20, such as to select a television program to be recorded from an electronic program guide (“EPG”) displayed on display device 40, and to respond to a screen message displayed on display device 40. Although not expressly indicated in FIG. 1, CPU 24 is operative to receive and process user inputs provided to apparatus 20 via remote control device 30. Display device 40 is operative to visually display images responsive to the video output signals provided from video processor 25, and may for example be embodied as a television screen, monitor, or other display device.

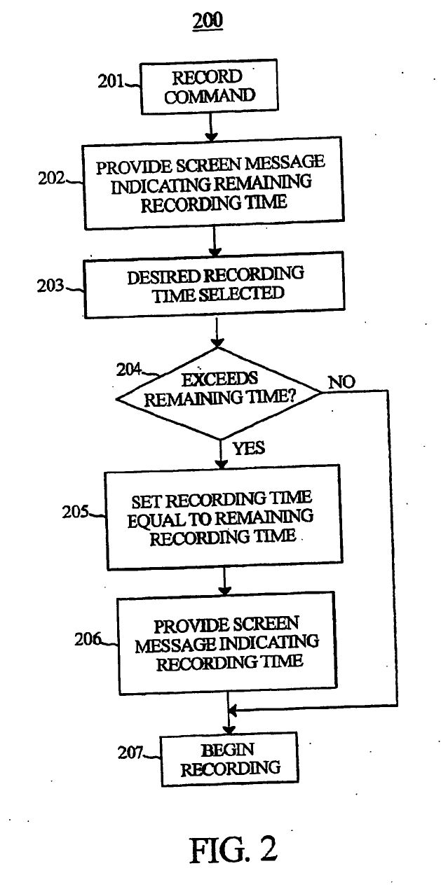

Referring now to FIG. 2, a flowchart 200 illustrating exemplary steps according to an embodiment of the present invention is shown. For purposes of example and explanation, the steps of FIG. 2 will be described with reference to digital recording apparatus 20 of FIG. 1. Accordingly, the steps of FIG. 2 are merely exemplary, and are not intended to limit the present invention in any manner.

At step 201, a user input command to start a recording operation is detected by apparatus 20. According to an exemplary embodiment, a user inputs the record command via remote control device 30 and the command is received and decoded by CPU 24. This record command may be, for example, generated in response to user actuation of the “RECORD” key on remote control device 30, which results in a record command without specifying a total recording time. Alternatively, the record command may be generated in response to an input responsive to an EPG displayed on display device 40, e.g., through a one-touch record method.

At step 202, a screen message indicating the remaining recording time available on memory 26 is displayed responsive to the record command. According to an exemplary embodiment, CPU 24 is programmed to determine the remaining recording time available on memory 26, and makes this determination based on parameters such as the remaining memory capacity (e.g., number of bytes) available on memory 26 and an anticipated bit rate (e.g., number of bits per second) of the incoming data stream, which may be set, for example, by user selection of a particular recording quality level, or by the bit rate provided by the broadcast source. For example, if the remaining memory capacity is 13.5 gigabytes and the bit rate of the incoming data stream is 20 megabits per second, then the remaining recording time available on memory 26 is: [(13.5)(8)×10⁹ bits] divided by [20×10⁶ bits per second]=5400 seconds or 1 hour and 30 minutes. Other ways of determining the remaining recording time available on memory 26 may also be used according to the present invention. By providing the screen message in response to a record command, in particular to a record command that does not specify a total record time, the user is able to easily determine the available recording time and whether the available time is sufficient for recording the desired program.

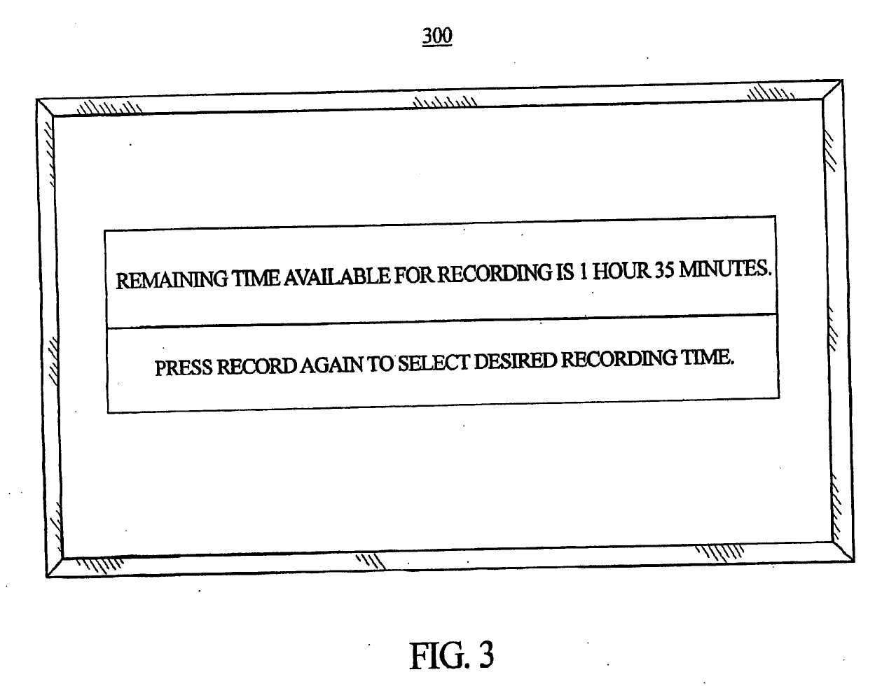

According to an exemplary embodiment, CPU 24 outputs data representative of the remaining recording time to video processor 25. CPU 24 also outputs a control signal which causes GUI generator 23 to generate a screen message and output the same to video processor 25. Video processor 25 inserts the remaining recording time determined by CPU 24 into the screen message generated by GUI generator 23 and outputs the resulting screen message for display via display device 40. An example of the screen message provided at step 202 is shown in FIG. 3.

As shown in FIG. 3, exemplary screen message 300 indicates the remaining recording time available on memory 26 of apparatus 20, which according to an example is 1 hour and 35 minutes. Screen message 300 also instructs the user to press the “RECORD” key in order to select a desired recording time. Screen message 300 is an example only, and other information such as time, date, input source (e.g., terrestrial, satellite, cable, internet, camcorder, etc.), and/or other information may also be provided and/or other formats used in screen message 300 according to the present invention.

At step 203, the user selects the desired recording time. According to an exemplary embodiment, the user provides an input via remote control device 30 to select the desired recording time. For example, the user may selectively manipulate a key a desired number of times, or a set of keys, on remote control device 30 to increase and/or decrease the recording time by predetermined time intervals (e.g., one press of the RECORD key for 10 minutes, two presses for 30 minutes, three presses for 1 hour, etc.) while display device 40 indicates the currently selected recording time. Once the desired recording time is displayed, the user may press a predetermined key (e.g., “ENTER”) on remote control device 30 to thereby select the desired recording time.

Next, at step 204, a determination is made as to whether the desired recording time selected at step 203 exceeds the remaining recording time available on memory 26. According to an exemplary embodiment, CPU 24 is programmed to make this determination by comparing the desired recording time selected at step 203 to the remaining time available on memory 26.

If the determination at step 204 is negative, process flow advances to step 207 where recording begins and is performed for the desired recording time selected at step 203. Alternatively, if the determination at step 204 is positive, process flow advances to step 205 where the actual recording time to be used in the recording operation is set equal to the remaining recording time available on memory 26. According to an exemplary embodiment, CPU 24 is programmed to set an internal timer (not shown) to the remaining recording time available on memory 26 in response to a positive determination at step 204.

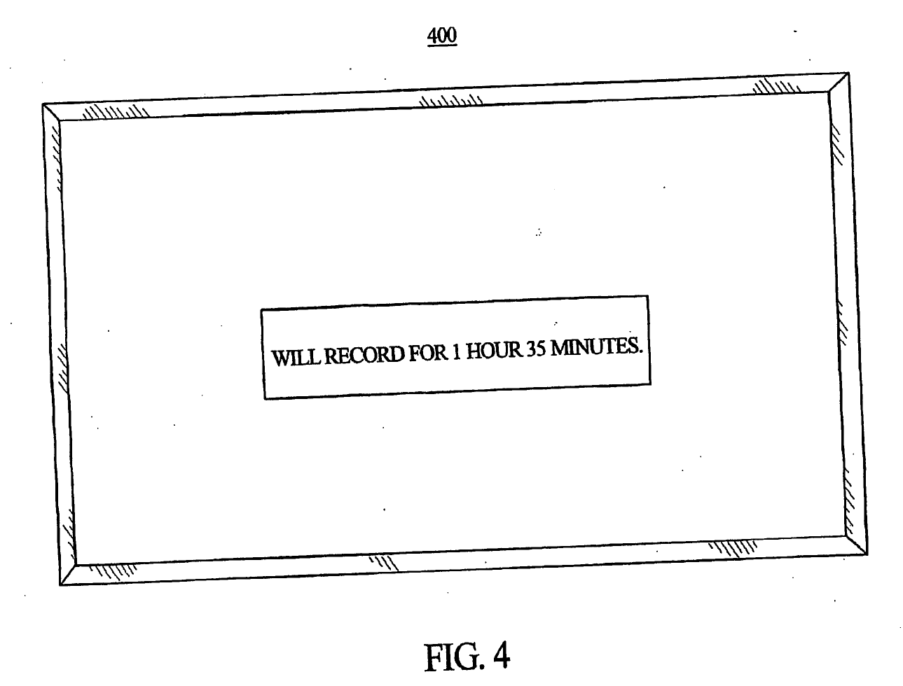

At step 206, a screen message indicating the actual recording time to be used in the recording operation is displayed for the user. According to an exemplary embodiment, CPU 24 outputs a control signal which causes GUI generator 23 to generate the screen message and output the same to video processor 25 for ultimate display via display device 40. An example of the screen message provided at step 206 Is shown in FIG. 4.

As shown in FIG. 4, exemplary screen message 400 indicates that the recording will be performed for 1 hour and 35 minutes, which according to the example is the remaining recording time available on memory 26. Screen message 400 is also only an example, and other information such as time, date, input source (e.g., terrestrial, satellite, cable, internet, camcorder, etc.), and/or other information may also be provided and/or other formats used in screen message 400 according to the present invention. Also in practice, steps 205 and 206 may be performed at the same time, or may be performed in reverse order.

At step 207, a recording operation begins. According to an exemplary embodiment, CPU 24 enables the recording operation by outputting a control signal which causes incoming video signals to be processed and stored in memory 26. In particular, CPU 24 enables recording to be performed for the desired recording time selected at step 203 if the determination at step 204 is negative. Alternatively, if the determination at step 204 is positive, CPU 24 enables recording to be performed only for the remaining recording time available on memory 26.

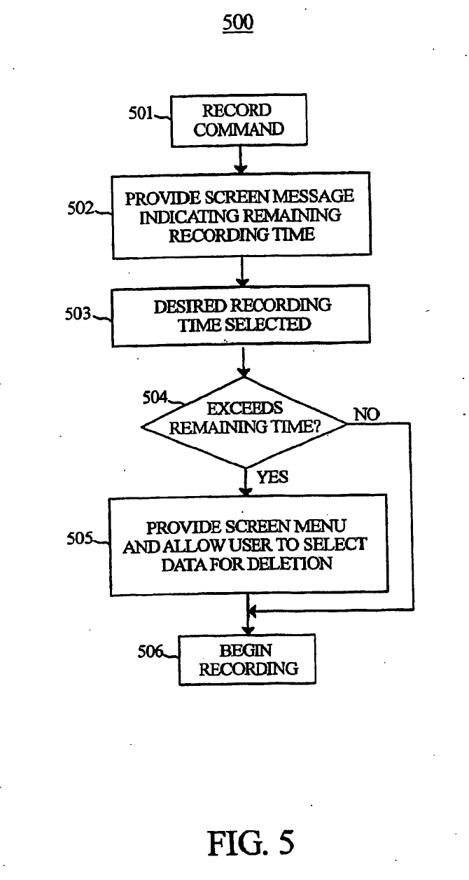

Referring now to FIG. 5, a flowchart 500 illustrating exemplary steps according to another embodiment of the present invention is shown. For purposes of example and explanation, the steps of FIG. 5 will also be described with reference to digital recording apparatus 20 of FIG. 1. Accordingly, the steps of FIG. 5 are merely exemplary, and are not intended to limit the present invention in any manner.

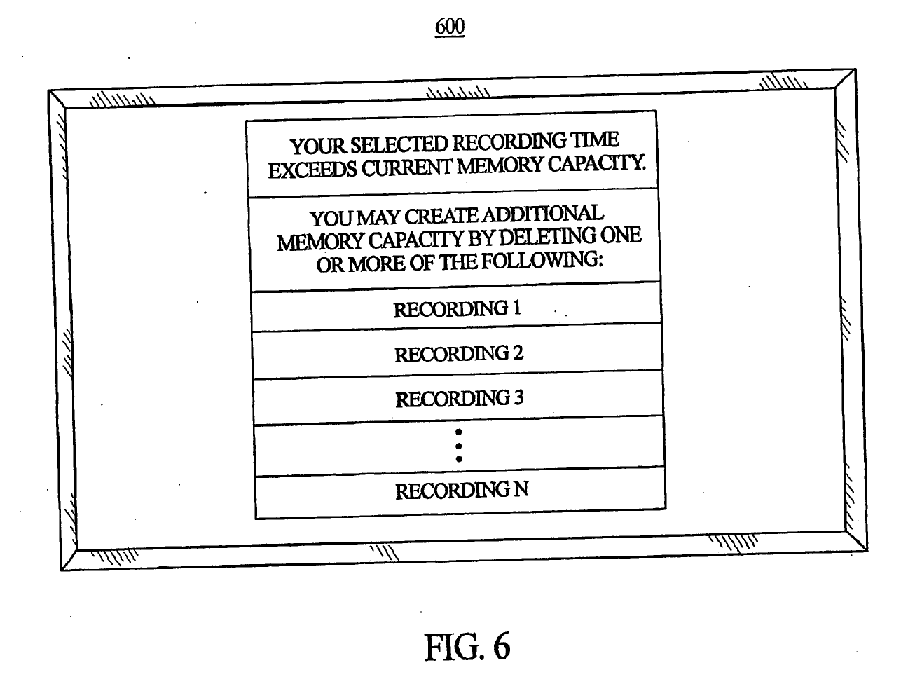

In FIG. 5, steps 501 to 504 are substantially identical to steps 201 to 204 of FIG. 2. Accordingly, for clarity of description, the reader is referred to the foregoing description of steps 201 to 204 of FIG. 2. The primary difference between the embodiments of FIGS. 2 and 5 begins at step 505. If CPU 24 determines at step 504 that the user's desired recording time exceeds the remaining recording time available on memory 26, process flow advances to step 505 where a screen message is displayed and the user is provided an opportunity to select data for deletion from memory 26. According to an exemplary embodiment, CPU 24 outputs a control signal which causes GUI generator 23 to generate the screen message and output the same to video processor 25 for ultimate display via display device 40. An example of the screen message provided at step 505 is shown in FIG. 6.

As shown in FIG. 6, exemplary screen message 600 indicates that the desired recording time selected by the user at step 503 exceeds the current recording capacity of memory 26. That is, the desired recording time exceeds the remaining recording time currently available on memory 26. Screen message 600 also informs the user that he or she may create additional memory capacity for recording by deleting one or more recordings currently stored on memory 26.

In FIG. 6, the user may selectively delete one or more of the recordings (i.e., RECORDING 1 to RECORDING N) currently stored on memory 26. For example, the user may manipulate keys on remote control device 30 to selectively move a highlighted cursor over a selected recording for deletion, and then press a predetermined key (e.g., “ENTER”) on remote control device 30 to effectuate the deletion from memory 26. According to an exemplary embodiment, CPU 24 detects the user input to delete a recording and outputs a control signal to memory 26 to thereby cause the recording indicated by the user input to be deleted from memory 26. In this manner, the user can free up data storage space on memory 26 and thereby extend the available recording time of apparatus 20. Of course, screen message 600 is also only an example, and other information may also be provided and/or other formats used in screen message 600 according to the present invention. The embodiment may be modified to provide yet another screen message immediately following a deletion operation that displays the revised available recording time remaining on the memory to allow the user to immediately determine whether the deletion operation freed up sufficient memory for the desired recording operation.

At step 506, a recording operation begins. According to an exemplary embodiment, CPU 24 enables the recording operation by outputting a control signal which causes incoming video signals to be processed and stored in memory 26. In particular, CPU 24 enables recording to be performed for the desired recording time selected at step 503 if the determination at step 504 is negative. Alternatively, if the determination at step 504 is positive, CPU 24 enables recording to be performed for the desired recording time only if the user has created sufficient additional memory space by deleting one or more recordings at step 505. If the user has not created additional memory space sufficient to accommodate the desired recording time, then recording is performed for the remaining recording time available on memory 26.

According to a modification of the embodiment of FIG. 5, recording may begin before the user actually deletes any recordings at step 505. Therefore, according to this variation step 506 would actually precede step 505 and recording would continue for the desired recording time if the user has created sufficient additional memory space by deleting one or more recordings.

As described herein, the present invention provides, among other things, a digital recording apparatus that advantageously allows the user to easily determine the available recording time remaining on a memory of the recording apparatus, and perform a deleting operation as desired to ensure that sufficient available recording time remains on the memory.

While this invention has been described as having a preferred design, the present invention can be further modified within the spirit and scope of this disclosure. This application is therefore intended to cover any variations, uses, or adaptations of the invention using its general principles. For example, it is clear that the principles of this invention is applicable to recording devices that utilize different recording media, or combination of media, such as CD and DVD discs. Thus, this invention may be utilized to provide information regarding available recording times remaining on each of the different recording media, or combination of media. Also, it is clear that the principles of this invention is applicable to devices wherein the memory device is disposed outside, or is externally connected to, the digital signal processing apparatus, for example, an environment wherein the signal processing functions are disposed within a digital set top box (DSTB) and the memory device is external to the DSTB, or is an allocated portion of a central server that is located at a service provider facility. Further, this application is intended to cover such departures from the present disclosure as come within known or customary practice in the art to which this invention pertains and which fall within the limits of the appended claims.

1. A method for controlling a digital recording apparatus, comprising the steps of:
detecting a first user input representing a command to start a recording operation;
determining an available recording time remaining on a memory of the apparatus; and
providing a first screen message indicating the available recording time remaining on the memory of the apparatus in response to the receipt of the first user input.

2. The method of claim 1, wherein the first user input comprises an actuation of a RECORD key on a remote control device associated with the digital recording apparatus.

3. The method of claim 1, wherein the first user input represents a command to start a recording operation without specifying a total recording time.

4. The method of claim 1, comprising the steps of:
providing a second screen message for allowing the user to select a desired recording time;
receiving a second user input representing the desired recording time;
determining whether the desired recording time exceeds the available recording time remaining on the memory of the apparatus; and
setting a recording time for the apparatus equal to the available recording time if the desired recording time exceeds the remaining recording time.

5. The method of claim 4, wherein the setting step comprises the step of setting a recording time equal to the desired recording time if the desired recording time does not exceed the available recording time.

6. The method of claim 4, wherein the step of receiving a second user input comprises determining the desired recording time in response to the number of times the RECORD key on the remote control device is actuated.

7. The method of claim 1, further comprising the steps of:
providing a second screen message for allowing the user to select a desired recording time;
receiving a second user input representing the desired recording time;
determining whether the desired recording time exceeds the available recording time remaining on the memory of the apparatus; and
providing a third screen message for allowing a user to select data for deletion from the memory of the apparatus if the desired recording time exceeds the remaining recording time.

8. The method of claim 7, further comprising the steps of:
determining a revised available recording time in response to user deletion of data from the memory of the apparatus; and
providing a fourth screen message indicative of the available remaining recording time in response to the user deletion of data.

9. The method of claim 7, further comprising the steps of determining a revised available recording time in response to user deletion of data from the memory of the apparatus, and setting the recording time to one of the desired recording time and the revised available recording time in response to the determination.

10. A digital recording apparatus, comprising:
means for receiving a video signal;
memory means for storing digital data;
means, coupled to the receiving means and the memory means, for processing the video signal for storage on the memory means, and for reading data on the memory means and providing an output signal suitable for display on a display device;
means for generating an on-screen display (“OSD”) message;
processing means for detecting a first user input representing a command to start a recording operation; and
image generating means, coupled to the generating means, for enabling display of a first screen message responsive to the processing means detecting the first user input, the first screen message indicating an available recording time remaining on the memory means.

11. The digital recording apparatus of claim 10, wherein the first user input is representative of user actuation of a RECORD key on a remote control device associated with the digital recording apparatus.

12. The digital recording apparatus of claim 10, wherein the first user input is representative of a command to start a recording operation without specifying a total recording time.

13. The digital recording apparatus of claim 10, wherein the processing means is further operative to detect a second user input representing a desired recording time, to determine whether the desired recording time exceeds the available recording time, and to set a recording time for the apparatus in response to the determination.

14. The digital recording apparatus of claim 13, wherein the processing means sets a recording time equal to the available recording time if the desired recording time exceeds the available recording time.

15. The digital recording apparatus of claim 13, wherein the processing means sets a recording time equal to the desired recording time if the desired recording time does not exceed the remaining recording time.

16. The digital recording apparatus of claim 13, wherein the desired recording time is determined in response to the number of time a user actuates the RECORD key on the remote control device.

17. The digital recording apparatus of claim 13, wherein the image generating means is operative to provide a second screen message for allowing the user to delete data from the memory means to increase the available recording time in response to determining that the desired recording time is greater than the available recording time, the processing means determining a revised available recording time in response to user input to delete data from the memory means.

18. The digital recording apparatus of claim 17, wherein the image generating means is operative to provide a third screen message indicating the revised available recording time, and the processing means is operative to determine whether the desired recording time is greater than the revised available recording time, and setting the recording time in response to the determination.
